(19) United States
(12) Patent Application Publication
(10) Pub. No.: US 2026/0088851 A1
(43) Pub. Date: Mar. 26, 2026

(54) ANTENNA CONTROL CIRCUIT WITH ADJUSTABLE IMPEDANCE

(71) Applicant: Infineon Technologies AG, Neubiberg (DE)

(72) Inventors: Julia Richter, Muenchen (DE); Fabian Schrott, Graz (AT); Stefan Schneider, Graz (AT); Raimondo Luzzi, Graz (AT)

(21) Appl. No.: 19/328,977

(22) Filed: Sep. 15, 2025

(30) Foreign Application Priority Data
Sep. 24, 2024 (DE) 102024209142.1

(51) Int. Cl. H04B 1/40; H04B 1/16

(52) U.S. Cl. CPC H04B 1/40; H04B 1/1607

(57) ABSTRACT

An antenna control circuit having an antenna terminal, an inverter circuit upstream of the antenna terminal having a plurality of PMOS field effect transistors connected in parallel and a plurality of NMOS field effect transistors connected in parallel, a current detection circuit connected upstream of the inverter circuit and configured to detect an electrical current at the input of the inverter circuit, and a logic configured to individually enable or disable each PMOS field effect transistor and/or each NMOS field effect transistor in order to change the impedance at the output of the inverter circuit depending on the electrical current detected by the current detection circuit.

### TECHNICAL FIELD

The present disclosure relates to an antenna control circuit, an antenna device and a method for operating an antenna control circuit.

### BACKGROUND

An NFC (Near Field Communication) or RFID (Radio Frequency Identification) reader for contactless communication may have a transmitter block connected to an antenna via a matching circuit. By means of this antenna, an electromagnetic carrier signal and modulated data information can be transmitted.

During active operation of the antenna, the inductive behavior of the antenna itself and the bonding wire, as well as a detuning of the antenna, which may be caused by production variations or other influencing factors, cause overshoot and undershoot at the antenna terminal pins when switching the transmission voltage.

Transmitters connected to the antenna may be damaged or malfunction may occur if the internal power supply (VDD and VSS) or antenna connectors are exposed to such overshoot and/or undershoot exceeding their operating limits or to severely distorted signals, which can lead to reliability problems.

### BRIEF DESCRIPTION

An antenna control circuit is provided. The antenna control circuit has an antenna terminal; an inverter circuit connected upstream of the antenna terminal having a plurality of PMOS field effect transistors connected in parallel and a plurality of NMOS field effect transistors connected in parallel; a current detection circuit connected upstream of the inverter circuit for detecting an electrical current at the input of the inverter circuit; and a logic for selecting to enable or disable each PMOS field effect transistor and/or each NMOS field effect transistor individually in order to change the impedance at the output of the inverter circuit depending on the electrical current detected by the current detection circuit.

An antenna device is provided. The antenna device comprises an antenna control circuit according to exemplary embodiments, the control circuit comprising an antenna terminal, and an antenna connected to the antenna terminal.

A method for operating an antenna control circuit comprising an inverter circuit is provided. The method comprises: detecting an electrical current at the input of the inverter circuit, and selecting to individually enable or disable each PMOS field effect transistor contained in the inverter circuit and/or each NMOS field effect transistor contained in the inverter circuit, in order to change the impedance at the output of the inverter circuit depending on the electrical current detected by the current detection circuit.

A person skilled in the art will discern further features and advantages of the invention upon reading the following detailed description and examining the attached drawings.

### BRIEF DESCRIPTION OF THE DRAWINGS

The present disclosure is shown in an exemplary and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1 shows a schematic representation of an antenna control circuit according to various exemplary embodiments.

FIG. 2 shows a schematic representation of an antenna control circuit according to various exemplary embodiments and illustrates a voltage waveform at its antenna terminal in comparison to an antenna terminal of an antenna control circuit according to the prior art.

FIG. 3 shows a schematic representation of an antenna control circuit according to various exemplary embodiments.

FIG. 4 illustrates aspects of the antenna control circuit according to various exemplary embodiments.

FIG. 5 illustrates selection sequences for individually enabling or disabling field effect transistors in an antenna control circuit according to various exemplary embodiments.

FIG. 6 shows a flow diagram of a method for operating an antenna control circuit according to various exemplary embodiments.

### DETAILED DESCRIPTION

The embodiments described here allow for predictive measures for matching an antenna driver impedance of an antenna control circuit by measuring an antenna current before switching an antenna driver voltage, wherein the measurement allows an estimation of a direction of the antenna current at the switching time.

In other words, a direction of the antenna current at the switching time for each carrier half-period can be estimated by detecting an antenna current of an antenna control circuit before switching an antenna driver voltage. This information can be used very briefly (˜ns) before the switching to take predictive actions for the driver impedance (in particular to match the driver impedance).

In order to limit overshoot and undershoot at the antenna terminals (e.g. antenna pins), for example, in the antenna control circuit which drives the antenna at the NFC communication frequency of 13.56 MHz, each NFC period of 1/13.56 MHz (˜74 ns) can be divided into 24 time segments of 3 ns each.

For the time segments shortly before and after the switching activity of the driver (the driver switches at the beginning and in the middle of the NFC period), according to various exemplary embodiments the driver impedance can be precisely controlled by changing the number of active parallel driver segments for the NMOS field effect transistors and the PMOS field effect transistors individually.

By measuring the current at approximately ¼ and ¾ of each NFC period—these being times during the period in which no switching takes place—at the antenna terminals of the antenna control circuit, it can be determined, for example, by means of a comparator, whether the current at the next driver switchover point will be positive or negative in relation to the switchover voltage.

By processing this information, the impedance of the driver can be slowly reduced (equivalent to clamping) to prevent overshoot at the antenna terminals, or increased (also known as shaping) to prevent a power supply from being constricted.

The measuring point in relation to the switching activity and the driver impedance can be set individually from memories (e.g. non-volatile memories, e.g. registers, e.g. so-called special function registers).

Various exemplary embodiments allow an antenna control circuit (which can be configured for example for near field communication (NFC) and can then be referred to as an NFC driver) to work with much higher transmission voltages than according to the prior art. Thus, a higher transmission power and load modulation amplitude within a given technology can be provided, which can increase a (transmitting) power of an antenna device. In addition, stacking of transistors on top of one another to split the overvoltage across multiple stacked transistors can be omitted and the area required for the antenna control circuit can be reduced. In addition, accuracy requirements on circuit components can be relaxed.

An antenna control circuit (for example, for a transmitter antenna (TX)) together with an antenna connected thereto can form a driven (damped) harmonic oscillator.

Accordingly, if not driven, an amplitude may decay, whereas driving at the resonant frequency of the antenna will maximize the amplitude.

However, if the system is driven at a frequency that is not the resonance frequency of the antenna, this can result in a maximum amplitude value being smaller than when driven at the resonance frequency, and furthermore, a phase offset (e.g. from −90° to +) 90° being more pronounced in less damped systems.

According to various exemplary embodiments, for example, the frequency at which the antenna is driven may be 13.56 MHz. The resonance frequency of the antenna, on the other hand, can vary, for example, depending on components that form part of the antenna circuit, for example capacitors and/or inductors, or due to other influencing factors.

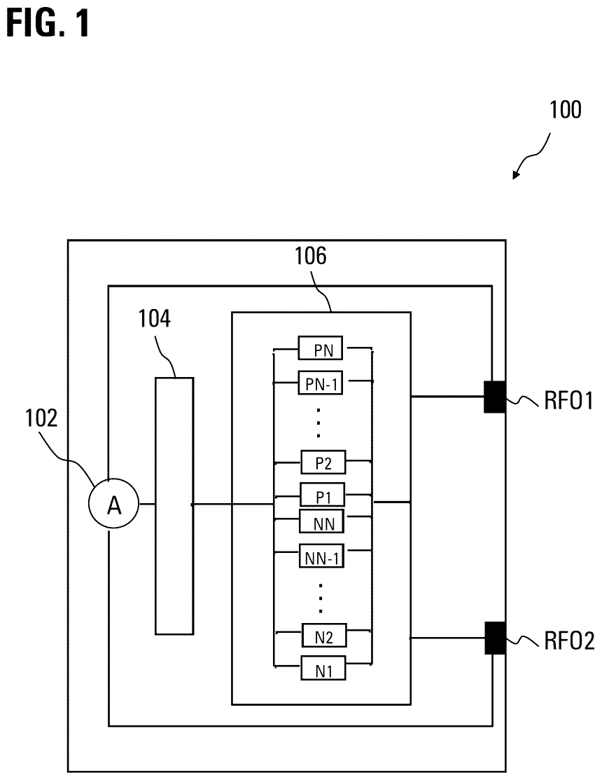

FIGS. 1 to 3 each show a schematic illustration of an antenna control circuit 100 according to various exemplary embodiments.

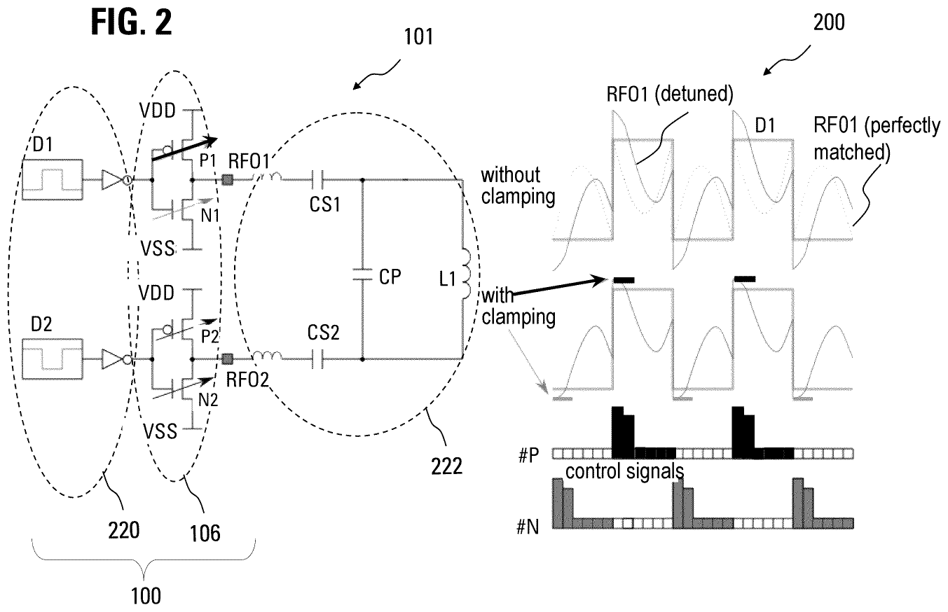

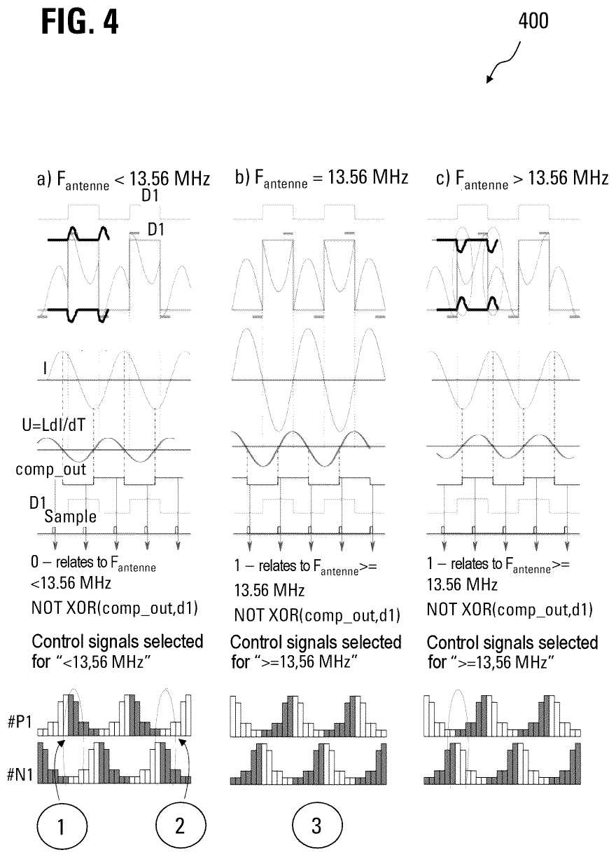

FIG. 2 further shows, in illustration 200, a voltage waveform at the antenna terminal of the antenna control circuit 100 in comparison to an antenna terminal of an antenna control circuit according to the prior art, and FIG. 4 illustrates aspects of the antenna control circuit 100 according to various exemplary embodiments.

The antenna control circuit 100 comprises an antenna terminal RFO1, RFO2, and an inverter circuit 106 connected upstream of the antenna terminal RFO1, RFO2 and having a plurality of parallel-connected PMOS field effect transistors P1, . . . , PN and a plurality of parallel-connected NMOS field effect transistors N1, . . . NN.

The antenna control circuit 100 further comprises a current detection circuit 102 connected upstream of the inverter circuit 106 for detecting an electrical current at the input of the inverter circuit 106. This means that the current detection circuit 102 is configured for detecting an electrical current in a signal chain before/upstream of the input of the inverter circuit 106, which may include, for example, detecting the electrical current at the antenna terminal RFO1, RFO2.

The antenna control circuit 100 further comprises a logic 104 for selecting to enable or disable each PMOS field effect transistor P1, . . . , PN and/or each NMOS field effect transistor N1, . . . NN individually in order to change the impedance at the output of the inverter circuit (and hence at the antenna terminal RFO1, RFO2) depending on the electrical current detected by the current detection circuit 102.

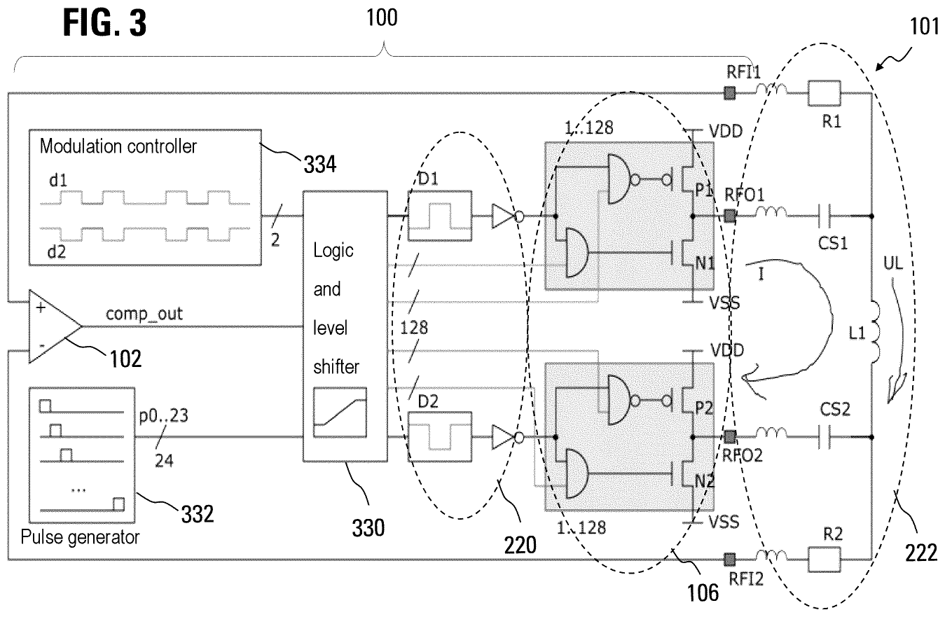

The plurality of parallel-connected PMOS field effect transistors P1, . . . , PN and the plurality of parallel-connected NMOS field effect transistors N1, . . . NN in the inverter circuit 106 can be configured in such a way that: either one or more of the plurality of PMOS field effect transistors P1, . . . , PN or one or more of the plurality of NMOS field effect transistors N1, . . . NN are enabled, but one or more PMOS field effect transistors P1, . . . , PN are not enabled simultaneously with one or more NMOS field effect transistors N1, . . . NN. For example, the PMOS field effect transistors P1, . . . , PN and the NMOS field effect transistors N1, . . . NN may be configured for achieving the inverter function of the inverter circuit 106 in such a way that: a high signal (logic 1) provided by the logic circuit 104 at the input of the inverter circuit 106 can switch one or more of the individually switchable NMOS transistors N1, . . . , NN to conducting and can switch the output of the inverter circuit 106 and hence the antenna input RFO1, RFO2 (or one of these at a time, because the two antenna inputs RFO1, RFO2 are outputs of two differentially switched branches of the inverter circuit 106) to a negative supply voltage VSS (e.g. ground) (logic 0). This is shown in more detail in particular in the schematic circuits of FIGS. 2 and 3, where the VSS and VDD supply terminals are also shown. Meanwhile, the plurality of PMOS transistors P1, . . . PN are blocked. If the input is low (logic 0), one or more of the individually switchable PMOS field effect transistors P1, . . . , PN are conducting and pulls or pull the output of the inverter circuit 106 and hence the antenna input RFO1, RFO2 (or one of them, e.g. the one that is not switched to VSS) up to the supply voltage VDD (logic 1), while the plurality of NMOS transistors N1, . . . , NN is blocked.

The fact that only either the PMOS transistors P1, . . . , PN or the NMOS transistors N1, . . . , NN are switched to conducting simultaneously is illustrated in particular in FIG. 4 in the lower two graphs labelled “#P1” and “#N1”.

The antenna control circuit 100 according to various exemplary embodiments may also: comprise a switching circuit 220, which is configured for the periodic digital switching of an antenna voltage applied to the inverter circuit 106. As mentioned above and illustrated in FIG. 2 to FIG. 4, the switching circuit 220 can be designed as a differential switching circuit 220, however it is not limited thereto.

In the antenna control circuit 100, the current detection circuit 102 can be configured to perform the detection of the electrical current I at at least one detection time, the time difference of which relative to a directly preceding digital switching is approximately equal to a time difference relative to a directly following digital switching.

“Directly preceding” or “directly following” is to be understood herein in such a way that there may be a time interval between the digital switching and the detection, but that no additional detection or switching operation is carried out within this time interval (e.g. in the sense of newly or additionally initiated).

In other words, the antenna control circuit 100 can be configured in such a way that the detection of the electrical current I takes place precisely at a time during the period, at which the value of the value of the electrical current I is not changing greatly due to a switching operation, but is relatively constant or at most changes slightly and continuously. This makes it possible for the detection of the electrical current I to provide a stable, reliable, relatively noise-free value for the electrical current I. For example, such a time is relatively midway between two switching times.

In various exemplary embodiments, the antenna control circuit 100 may comprise a pulse generator 332, which may be configured to provide the logic circuit 330 with a sequence of pulses for timing of control operations of the antenna control circuit 100. That is illustrated by way of example in FIG. 3. The sequence of pulses can be configured, for example, such that each period is divided into sufficiently many pulses to be able to assign at least one of the pulses to each relevant control operation.

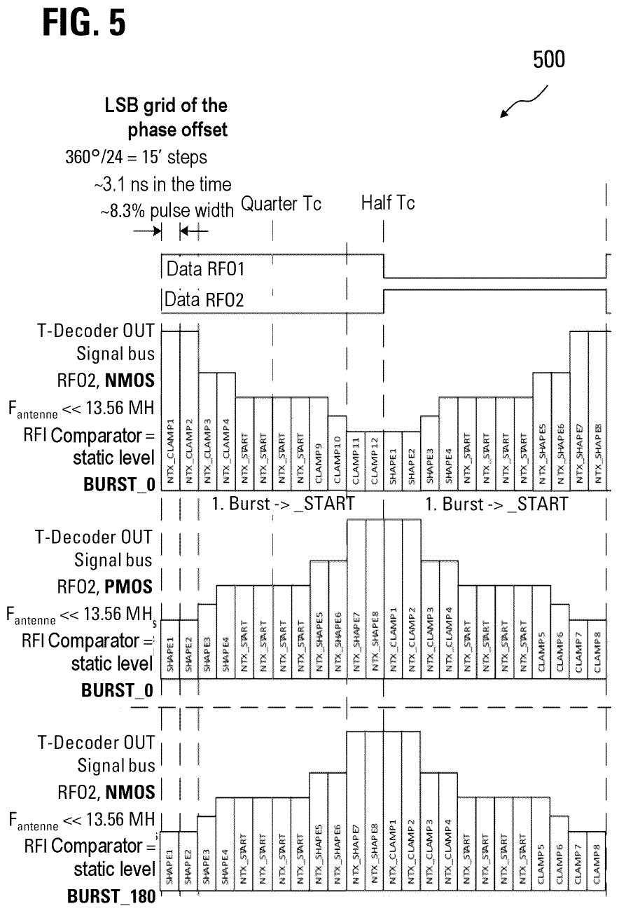

As an example, in the embodiment of FIG. 3 the NFC period, which has a length of approximately 74 ns (1/13.56 MHz), is divided into 24 pulses or time segments of approximately 3 ns each. In FIGS. 2 and 4, for clarity, only half as many pulses are shown for illustrating the enabling of the PMOS field effect transistors P1, . . . , PN or the NMOS field effect transistors, but FIG. 5 in the overview 500 shows, for each of the exemplary 24 pulses or time segments for three scenarios (which are further explained below), when additional NMOS field effect transistors or PMOS field effect transistors N1, . . . , NN or P1, . . . , PN are to be enabled, also referred to as clamping or in FIG. 5 labelled “CLAMP”, to decrease the impedance at the output of the inverter circuit 106 or not (“SHAPE”). “Additional” NMOS or PMOS field effect transistors means that there is a predetermined nominal number of active NMOS or PMOS field effect transistors (not simultaneously, but either one or the other), and that the additional NMOS or PMOS field effect transistors increase the number of active NMOS or PMOS field effect transistors beyond the predetermined nominal number, thereby decreasing the impedance at the output of the inverter circuit 106 below the value achieved with the nominal number (to limit the voltage overshoot or undershoot).

In addition, the number of active NMOS or PMOS field effect transistors can be reduced below the predetermined nominal number, thereby increasing the impedance at the output of the inverter circuit 106 above the value achieved with the nominal number (to prevent or weaken the constriction of the supply voltage).

The time segments of approximately 3 ns defined by the pulses of the pulse generator 332 can make it possible to position the detection time at about a quarter and three-quarters of the period, about five to six pulses away from the switching times. Both in FIG. 4 and in FIG. 5 detection times are indicated by vertical lines and labelled “Sample” or “Quarter Tc”.

The time interval between the detection time and the subsequent switching operation, at which the matching resulting from the measurement is to be performed, may be sufficient for forwarding the measurement result to other circuit components.

Thereupon the antenna control circuit 100 can enable the PMOS field effect transistors and/or NMOS field effect transistors selected by the logic to perform a digital switching of the antenna voltage directly following a detection time of the electrical current. For example, at the first switching time, which directly follows the first detection time, only the PMOS field effect transistors P1, . . . , PN selected by the logic can be enabled and at the second switching time, which directly follows the second detection time, only the NMOS field effect transistors selected by the logic can be enabled.

Each period of the periodic switching may have a first switching time and a second switching time, wherein the at least one detection time comprises a first detection time and a second detection time per period.

The detection and switching described above is shown in particular in FIG. 2, right half, and in FIG. 4.

FIG. 2 additionally shows (top right, the part marked as “without clamping”) a waveform of the current intensity at the first antenna terminal RFO1 for an antenna control circuit which is operated according to the prior art: there, a dashed line describes the ideal case for an antenna with a resonance frequency at the expected 13.56 MHz. In this case, zero crossings of the current sine curve are located at the switching times and the maximum current values are within the expected range, so that limiting the current value is superfluous. The solid line in the “no clamping” case, on the other hand, shows an antenna with a resonance frequency that is detuned compared to the expected 13.56 MHz. As the comparison with FIG. 4, case a) shows, the detuned antenna of FIG. 2 has a resonant frequency Fₐₙₜₑₙₙₐ that is lower than the expected 13.56 MHz. This can, as shown in FIG. 2 at the top right, cause overshooting both upwards and downwards.

The overshoot in the case of the antenna with the too low resonance frequency Fₐₙₜₑₙₙₐ can be limited, as shown in FIG. 2 bottom right and in FIG. 4 for case a), by enabling the PMOS field effect transistors P1, . . . , PN or the NMOS field effect transistors in a temporally matched manner.

The first and second switching times can be separated by half a period (in the case of the NFC approximately 37 ns).

Accordingly, the phase position of the current in a first example (which can also be referred to as the first matching requirement state) can be such that at the first switching time the current intensity is higher than the average value, and at the second switching time the current intensity is lower than the average value. This example case is illustrated in FIG. 2 and FIG. 4, Example a). There, the phase position with the increased current value at the first switching time is caused by the resonance frequency of the antenna being too low.

In the first switching time, the switching circuit 220, which is configured for the periodic digital switching of the antenna voltage, switches the digital driver signal D1 from 0 to 1 (in the case of the differential circuit, which is illustrated in FIG. 2 and FIG. 3, the digital driver signal D2 of a second branch of the switching circuit is switched synchronously thereto from 1 to 0, but the second branch is omitted with regard to current waveform, etc. in FIG. 2 and FIG. 4).

In this case, the PMOS field effect transistors P1, . . . , PN, as illustrated in the line labelled “#P1”, can be enabled at the first switching time to avoid the overshoot (upwards) described above, while the number of (additionally) enabled NMOS field effect transistors N1, . . . . NN is minimized to limit a transverse current.

This is to be understood as generally preventing simultaneous enabling of the PMOS field effect transistors P1, . . . , PN and the NMOS field effect transistors N1, . . . , NN. For example, the switching circuit 220, for example, the digital driver signal D1 (or in the case of differential switching, the digital driver signals D1 and D2) can be configured such that optionally, either the PMOS field effect transistors P1, . . . , PN or the NMOS field effect transistors N1, . . . , NN are active. However, the situation may be less clear at the exact time of switching, so that in the presence of both PMOS field effect transistors and NMOS field effect transistors, which are simultaneously switched to conducting, a transverse current is generated.

This transverse current can be minimized by avoiding a situation where switching takes place directly from many active PMOS field effect transistors to many active NMOS field effect transistors (or vice versa), but instead the number of the currently active additional field effect transistors (e.g. the NMOS field effect transistors N1, . . . , NN) is already minimized (e.g. to zero) before the switching time, while a number of the currently non-conducting additional field effect transistors (e.g. PMOS field effect transistors P1, . . . , PN) is already raised to the determined number so that their number is set correctly when switching (where the field effect transistors become conducting—and thus active). At the time of switching, there may then be a large number of additional conducting PMOS field effect transistors P1, . . . , PN, but no (or at most very few) conducting additional NMOS field effect transistors N1, . . . , NN.

In various exemplary embodiments, the pulses can be used to gradually reduce the number of additionally enabled PMOS field effect transistors P1, . . . , PN to zero before a subsequent detection time. In other words, one or more of the subsequent time periods indicated by the pulses can be used to disable one or more of the additionally enabled PMOS field effect transistors P1, . . . , PN.

In the second switching time, the switching circuit 220, which is configured for the periodic digital switching of the antenna voltage, switches the digital driver signal D1 from 1 to 0 (in the case of the differential circuit, which is illustrated in FIG. 2 and FIG. 3, the digital driver signal D2 of a second branch of the switching circuit is switched synchronously thereto from 0 to 1, but the second branch is omitted with regard to current waveform, etc. in FIG. 2 and FIG. 4).

In this case, the NMOS field effect transistors N1, . . . , NN, as illustrated in the line labelled “#N1”, can be enabled at the second switching time to avoid the overshoot (downwards) described above, while the number of (additionally) enabled PMOS field effect transistors P1, . . . , PN is minimized to limit a transverse current. In various exemplary embodiments, the pulses can be used to gradually reduce the number of additionally enabled NMOS field effect transistors N1, . . . , NN to zero before a subsequent detection time. In other words, one or more of the subsequent time periods indicated by the pulses can be used to disable one or more of the additionally enabled NMOS field effect transistors N1, . . . , NN.

In a second example (which can also be referred to as the second matching requirement state) it can be such that at the first switching time the current intensity is lower than the average value, and at the second switching time the current intensity is higher than the average value. This example case is illustrated in FIG. 4, Example c). There, the phase position with the increased current value at the first switching time is caused by the resonance frequency of the antenna being too high.

In the first switching time, the switching circuit 220, which is configured for the periodic digital switching of the antenna voltage, switches the digital driver signal D1 from 0 to 1 (in the case of the differential circuit, which is illustrated in FIG. 2 and FIG. 3, the digital driver signal D2 of a second branch of the switching circuit is switched synchronously thereto from 1 to 0, but the second branch is omitted with regard to current waveform, etc. in FIG. 2 and FIG. 4).

In this case, the NMOS field effect transistors N1, . . . , NN, as illustrated in the line labelled “#N1”, can be enabled at the first switching time to avoid “constricting” supply voltages (meaning a situation where the entire available current amplitude is not used), while the number of (additionally) enabled PMOS field effect transistors P1, . . . , PN is minimized to limit a transverse current. In various exemplary embodiments, the pulses can be used to gradually reduce the number of additionally enabled NMOS field effect transistors N1, . . . , NN to zero before a subsequent detection time. In other words, one or more of the subsequent time periods indicated by the pulses can be used to disable one or more of the additionally enabled NMOS field effect transistors N1, . . . , NN.

In the second switching time, the switching circuit 220, which is configured for the periodic digital switching of the antenna voltage, switches the digital driver signal D1 from 1 to 0 (in the case of the differential circuit, which is illustrated in FIG. 2 and FIG. 3, the digital driver signal D2 of a second branch of the switching circuit is switched synchronously thereto from 0 to 1, but the second branch is omitted with regard to current waveform, etc. in FIG. 2 and FIG. 4).

In this case, the PMOS field effect transistors P1, . . . , PN, as illustrated in the line labelled “#P1”, can be enabled at the second switching time to avoid the “constriction” described above, while the number of (additionally) enabled NMOS field effect transistors is minimized to limit a transverse current. In various exemplary embodiments, the pulses can be used to gradually reduce the number of additionally enabled PMOS field effect transistors P1, . . . , PN to zero before a subsequent detection time. In other words, one or more of the subsequent time periods indicated by the pulses can be used to disable one or more of the additionally enabled PMOS field effect transistors P1, . . . , PN.

FIG. 4 also shows, as Example b), the case where the antenna has the intended resonance frequency of 13.56 MHz. This case may be treated in exactly the same way as Example c), because such a case is unlikely to occur in practice anyway.

Which of the cases is present—Example a), in which, when the driver signal of the switching circuit 220 is switched high, the additional PMOS field effect transistors P1, . . . , PN are to be enabled or Example c), in which the additional NMOS field effect transistors N1, . . . , NN are to be enabled—can be determined in various exemplary embodiments by means of the current detection circuit 102 at the detection times, which are each arranged approximately halfway between the switching times.

Since a current value detected before the switching point at the time of detection is used for correctively controlling the current at the switching time, the matching or correction process can also be considered as predictively preventing or reducing overshoot.

As illustrated in FIG. 4 for Example a), at the detection time (these are labeled with “Sample”) that occurs before the first switching time the current intensity is higher than the average value. This can be determined by means of the current detection circuit 102, which can be formed, for example, as a comparator and can output a higher of two digital signals (labeled with comp_out).

The current detected by the current detection circuit 102 (here in the form of the comp_out signal, but any other useful signal that can be evaluated as a control signal and represents the detected current, can be used instead of the comparator signal) can be used to select which control signals are to be applied: those for an antenna with a resonance frequency that is too low as in Example a) of FIG. 4, or those for an antenna with a resonance frequency that is too high as in Example c) of FIG. 4.

In a similar way as already shown in FIG. 2 and explained in this regard, as FIG. 4 shows (see the position marked with an ellipse and labelled “1”), this can cause the overshoot to be cut off (by increasing #P1) and limiting of the transverse current (by reducing #N1 to a minimum).

At the point marked with another ellipse and labelled “2”, it is illustrated that the undershoot is cut off (by increasing #N1) and the transverse current is limited (by reducing #P1 to a minimum).

Example a) from FIG. 4 further illustrates that reducing transverse currents when switching the antenna outputs immediately reduces overshoot and improves signal integrity for communication with other chips.

Example b) shows that in a case where the resonance frequency is at 13.56 MHz, the countermeasures are still active (e.g. as in the case of too high a resonance frequency) because this case actually does not occur in practice, because chips are actually always slightly detuned.

Example c) also shows that, in addition to limiting overshoot/undershoot, a constriction of the supply voltages is reduced here.

In various exemplary embodiments, control signals (e.g., enable/disable signals for all PMOS and NMOS field effect transistors) for each of the pulses or time segments may be stored, for example, in a register, and from there sequentially retrieved. The control signals stored after pulses or time steps are partially illustrated in FIG. 5.

There, the two upper examples labeled with “BURST_0” correspond to driving in phase and hence to the situation that is described, for example, in FIG. 2, FIG. 3 and FIG. 4 for controlling the NMOS and PMOS field effect transistors.

The example denoted by BURST_180, on the other hand, illustrates driving with an inverted phase, in which a current flow in the antenna must first be attenuated or, at high transmission power, even reversed.

In various exemplary embodiments, a plurality of memories or memory areas (e.g. registers) can be provided, which each provide, in the form of a lookup table, entries for different conductivity types of the field effect transistors, too low/too high resonance frequency of the antenna, first or second branch of the differential switching circuit, etc. (as a plurality of lookup tables), or some or all variants may optionally be stored together in one memory (possibly as a common lookup table).

The described matching procedures can be carried out continuously during useful operation of the antenna control circuit.

FIGS. 2 and 3 further show an antenna device 101, which has an antenna control circuit 100 according to various exemplary embodiments and the antenna 222 connected to the antenna terminal RFO1, RFO2.

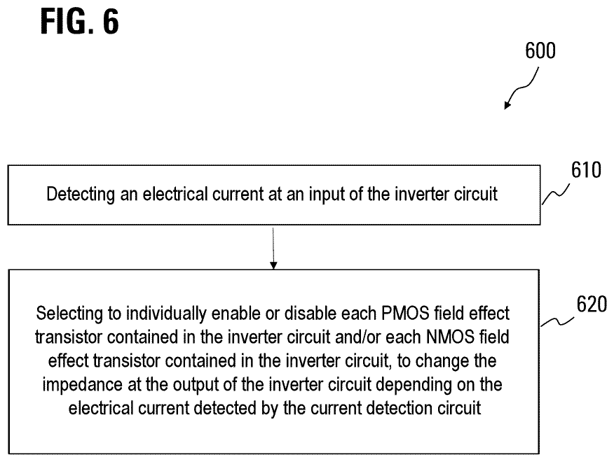

FIG. 6 shows a flow diagram 600 of a method for operating an antenna control circuit according to various exemplary embodiments, which comprises an inverter circuit. The method comprises: detecting an electrical current at the input of the inverter circuit (610), and selecting to individually enable or disable each PMOS field effect transistor contained in the inverter circuit and/or each NMOS field effect transistor contained in the inverter circuit, in order to change the impedance at the output of the inverter circuit depending on the electrical current (620) detected by the current detection circuit.

There follows a summary of a few exemplary embodiments.

Exemplary embodiment 1 is an antenna control circuit. The antenna control circuit has an antenna terminal; an inverter circuit connected upstream of the antenna terminal having a plurality of PMOS field effect transistors connected in parallel and a plurality of NMOS field effect transistors connected in parallel; a current detection circuit connected upstream of the inverter circuit for detecting an electrical current at the input of the inverter circuit; and a logic for selecting to enable or disable each PMOS field effect transistor and/or each NMOS field effect transistor individually in order to change the impedance at the output of the inverter circuit depending on the electrical current detected by the current detection circuit.

Exemplary embodiment 2 is an antenna control circuit according to exemplary embodiment 1, further comprising: a switching circuit configured for the periodic digital switching of an antenna voltage which is applied to the inverter circuit.

Exemplary embodiment 3 is an antenna control circuit according to exemplary embodiment 2, wherein the current detection circuit is configured to perform the detection of the electrical current at at least one detection time, the time difference of which relative to a directly preceding digital switching is approximately equal to a time difference relative to a directly following digital switching.

Exemplary embodiment 4 is an antenna control circuit according to exemplary embodiment 2 or 3, which is configured to enable the PMOS field effect transistors and/or NMOS field effect transistors selected by the logic to perform a digital switching of the antenna voltage directly following the detection time of the electrical current.

Exemplary embodiment 5 is an antenna control circuit according to exemplary embodiment 3 or 4, wherein each period of the periodic switching has a first switching time and a second switching time, and

wherein the at least one detection time comprises a first detection time and a second detection time per period.

Exemplary embodiment 6 is an antenna control circuit according to exemplary embodiment 5, configured to enable, at the first switching time which directly follows the first sensing time, only the PMOS field effect transistors selected by the logic.

Exemplary embodiment 7 is an antenna control circuit according to exemplary embodiment 6, further configured to disable at least one of the enabled PMOS field effect transistors before the subsequent detection time.

Exemplary embodiment 8 is an antenna control circuit according to exemplary embodiment 5 or 6, configured to enable, at the second switching time which directly follows the first sensing time, only the NMOS field effect transistors selected by the logic.

Exemplary embodiment 9 is an antenna control circuit according to exemplary embodiment 8, further configured to disable at least one of the enabled PMOS field effect transistors before the subsequent detection time.

Exemplary embodiment 10, an antenna control circuit according to one of the exemplary embodiments 1 to 9, configured to perform the detection of the electrical current and to enable or disable each PMOS field effect transistor and/or each NMOS field effect transistor individually during useful operation of the antenna control circuit.

Exemplary embodiment 11 is an antenna control circuit according to one of the exemplary embodiments 2 to 10, wherein the switching circuit is configured as a differential circuit.

Exemplary embodiment 12 is an antenna control circuit according to one of the exemplary embodiments 1 to 11, wherein the PMOS field effect transistors and/or NMOS field effect transistors to be selected for individual enabling or disabling are provided by means of at least one lookup table.

Exemplary embodiment 13 is an antenna control circuit according to exemplary embodiment 12, wherein the at least two lookup tables and the logic are configured to select at least one of the lookup tables for selecting the PMOS field effect transistors and/or the NMOS field effect transistors.

Exemplary embodiment 14 is an antenna control circuit according to one of the exemplary embodiments 1 to 13, wherein the current detection circuit comprises a comparator.

Exemplary embodiment 15 is an antenna control circuit according to one of the exemplary embodiments 2 to 14, wherein the current detection circuit is configured to distinguish between a first matching requirement state, in which an antenna connected to the antenna terminal has a resonance frequency which is higher than a frequency corresponding to the period of the switching circuit, and a second matching requirement state, in which an antenna connected to the antenna terminal has a resonance frequency which is lower than a frequency corresponding to the period of the switching circuit.

Exemplary embodiment 16 is an antenna control circuit according to exemplary embodiments 13 and 15, wherein a first lookup table of the at least two lookup tables is assigned to the first matching requirement state, and a second lookup table of the at least two lookup tables is assigned to the second matching requirement state.

Exemplary embodiment 17 is an antenna control circuit according to one of the exemplary embodiments 12 to 16, further comprising: at least one register for storing the at least one lookup table.

Exemplary embodiment 18 is an antenna device which has an antenna control circuit according to one of the exemplary embodiments 1 to 17 and an antenna connected to the antenna terminal.

Exemplary embodiment 19 is a method for operating an antenna control circuit comprising an inverter circuit, the method comprising: detecting an electrical current at the input of the inverter circuit, and selecting to individually enable or disable each PMOS field effect transistor contained in the inverter circuit and/or each NMOS field effect transistor contained in the inverter circuit, in order to change the impedance at the output of the inverter circuit depending on the electrical current detected by the current detection circuit.

Further advantageous configurations of the apparatus are evident from the description of the method, and vice versa.

It should be pointed out that the description and the drawings only illustrate the principles of the proposed methods and devices. A person skilled in the art will be capable of implementing different arrangements which, although they are not expressly described or shown here, embody the principles of the invention and are contained within the scope thereof. In addition, all examples and embodiments outlined in the present document are intended fundamentally and expressly for explanatory purposes only, in order to help the reader understand the principles of the proposed processes and devices. In addition, all statements in this document that describe principles, aspects and embodiments of the invention and specific examples thereof are also intended to encompass their equivalents.

1. An antenna control circuit, comprising:
an antenna terminal;
an inverter circuit connected upstream of the antenna terminal and having a plurality of PMOS field effect transistors connected in parallel and a plurality of NMOS field effect transistors connected in parallel;
a current detection circuit connected upstream of the inverter circuit and configured to detect an electrical current at an input of the inverter circuit; and
a logic configured to individually enable or disable each PMOS field effect transistor and/or each NMOS field effect transistor in order to change an impedance at an output of the inverter circuit depending on the electrical current detected by the current detection circuit.

2. The antenna control circuit as claimed in claim 1, further comprising:
a switching circuit configured to periodically digitally switch an antenna voltage applied to the inverter circuit.

3. The antenna control circuit as claimed in claim 2, wherein the current detection circuit is configured to detect the electrical current at at least one detection time, a time difference of which relative to a directly preceding digital switching is approximately equal to a time difference relative to a directly following digital switching.

4. The antenna control circuit as claimed in claim 2, configured to enable the PMOS field effect transistors and/or NMOS field effect transistors selected by the logic for digital switching of the antenna voltage directly following a detection time of the electrical current.

5. The antenna control circuit as claimed in claim 3,
wherein each period of the periodic switching comprises a first switching time and a second switching time; and
wherein the at least one detection time comprises a first detection time and a second detection time per period.

6. The antenna control circuit as claimed in claim 5, configured to enable, at the first switching time which directly follows the first detection time, only the PMOS field effect transistors selected by the logic.

7. The antenna control circuit as claimed in claim 6, configured to disable at least one of the enabled PMOS field effect transistors before a subsequent detection time.

8. The antenna control circuit as claimed in claim 5, configured to enable only the NMOS field effect transistors selected by the logic at the second switching time which immediately follows the second detection time.

9. The antenna control circuit as claimed in claim 8, configured to disable at least one of the enabled PMOS field effect transistors before a subsequent detection time.

10. The antenna control circuit as claimed in claim 1, configured to detect the electrical current and to individually enable or disable each PMOS field effect transistor and/or each NMOS field effect transistor during useful operation of the antenna control circuit.

11. The antenna control circuit as claimed in claim 2, wherein the switching circuit is configured as a differential circuit.

12. The antenna control circuit as claimed in claim 1, wherein the PMOS field effect transistors and/or NMOS field effect transistors to be selected to be individually enabled or disabled are provided by means of at least one lookup table.

13. The antenna control circuit as claimed in claim 12, wherein at least two lookup tables and the logic are configured to select at least one of the lookup tables for selecting the PMOS field effect transistors and/or the NMOS field effect transistors.

14. The antenna control circuit as claimed in claim 1, wherein the current detection circuit comprises a comparator.

15. The antenna control circuit as claimed in claim 2, wherein the current detection circuit is configured to distinguish between:
a first matching requirement state, in which an antenna connected to the antenna terminal has a resonance frequency higher than a frequency corresponding to the period of the switching circuit, and
a second matching requirement state, in which an antenna connected to the antenna terminal has a resonance frequency lower than a frequency corresponding to the period of the switching circuit.

16. The antenna control circuit as claimed in claim 13, wherein a first lookup table of the at least two lookup tables is assigned to the first matching requirement state, and a second lookup table of the at least two lookup tables is assigned to the second matching requirement state.

17. The antenna control circuit as claimed in claim 12, further comprising:
at least one register configured to store the at least one lookup table.

18. An antenna device, comprising:
an antenna control circuit as claimed in claim 1; and
an antenna connected to the antenna terminal.

19. A method for operating an antenna control circuit having an inverter circuit, the method comprising:
detecting an electrical current at an input of an inverter circuit; and
selecting to individually enable or disable each PMOS field effect transistor in the inverter circuit and/or each NMOS field effect transistor contained in the inverter circuit, to change an impedance at an output of the inverter circuit depending on the electrical current detected by the current detection circuit.
